(19) United States
(12) Patent Application Publication
(10) Pub. No.: US 2013/0259616 A1
(43) Pub. Date: Oct. 3, 2013

(54) APPARATUS AND METHOD FOR LOADING AND OFFLOADING A STORAGE CONTAINER ONTO AND FROM A BED OF A TRANSPORT TRUCK

(71) Applicant: Thomas J. Logano, Concord, NC (US)

(72) Inventor: Thomas J. Logano, Concord, NC (US)

(21) Appl. No.: 13/438,114

(22) Filed: Apr. 3, 2012

(51) Int. Cl. B60P 1/00; B60P 3/00

(52) U.S. Cl. 414/541; 414/812

(57) ABSTRACT

An apparatus and method for loading and offloading storage containers such as dumpsters onto and from a bed of a transport truck utilizes a mast mounted in upstanding disposition relative to the bed of the truck, and a container lifting and placement assembly configured for grasping engagement with the storage container. The lifting and placement assembly is supported on the mast for selective movement upwardly and downwardly along the mast axis and for selective movement rotationally about the mast axis between a loading position facing away from the bed and a storage position disposed over the bed to facilitate selective positioning and movement of the assembly relative to the mast and the bed for grasping, lifting, moving, lowering and placing a storage container between a ground surface adjacent the truck and the truck bed.

### FIELD OF THE INVENTION

The present invention relates generally to trucks for transporting storage containers and, more particularly, to trucks for transporting waste containers, especially waste containers of the type commonly referred to as dumpsters.

### BACKGROUND OF THE INVENTION

Large trash receptacles, commonly referred to as dumpsters, are in widespread and common use, especially among businesses, commercial establishments, multifamily residential complexes such as apartment buildings, and various other facilities where large amounts of trash are generated. Dumpsters are typically large and heavy objects, made of thick-gauge steel to be capable of holding sizable quantities of trash, e.g., up to 10 cubic yards, and to withstand heavy-duty use over extended periods of time. Because of their size and weight, powerful automated equipment is required to lift and move dumpsters, e.g., when emptying or replacement is periodically required and for transportation between differing locations. Typically, specialized trucks are utilized for these purposes. Various forms of such specialized trucks are known. Representative examples may be found in U.S. Pat. Nos. 4,278,390; 4,778,327; 5,427,495; 5,816,764; and 6,705,823; and US Patent Application Publication 2010/0111655.

Substantially all commercially available trucks designed for transporting dumpsters and similar trash receptacles are adapted for carrying only a single dumpster or container at a time, which is recognized to have significant limitations and inefficiencies. The aforementioned US Patent Application Publication 2010/0111655 discloses a truck intended to carry multiple trash storage containers, but such truck is not known to have yet achieved any level of commercial use. Moreover, the truck disclosed in this patent application has the limitation that the trash storage containers must be offloaded in the reverse order in which they were originally loaded onto the truck, i.e., the truck does not have the capability of selectively offloading any individual trash storage container.

Accordingly, there exists a recognized need in the refuse handling industry for trucks having a simple and easy to operate arrangement for loading and offloading multiple dumpsters or other like trash storage containers. In particular, there is a need for such an apparatus that facilitates selective offloading of any individual container at any time.

### SUMMARY OF THE INVENTION

The present invention seeks to provide an apparatus and a method for loading and offloading storage containers onto and from a bed of a transport truck which improves upon known transport trucks and, in particular, meets the aforementioned needs.

Briefly summarized, the apparatus of the present invention basically comprises a mast mounted in upstanding disposition relative to the bed of the truck and defining a mast axis, and a container lifting and placement assembly configured for grasping engagement with the storage container. The lifting and placement assembly is supported on the mast for selective movement upwardly and downwardly along the mast axis and for selective movement rotationally about the mast axis between a loading position facing away from the bed and a storage position disposed over the bed to facilitate selective positioning and movement of the assembly relative to the mast and relative to the bed for grasping, lifting, moving, lowering and placing a storage container between a ground surface adjacent the truck and the truck bed.

In a contemplated embodiment, the bed has an end rearwardly of the truck, with the mast being mounted adjacent the rear end of the bed. The lifting and placement assembly may preferably be rotatable approximately 180 degrees about the mast axis. The lifting and placement assembly may include projecting spaced-apart arms for engagement with a storage container. The lifting and placement assembly may preferably utilize hydraulic means for actuating the described upward, downward and rotational movements thereof

The apparatus may advantageously include a second lifting and placement assembly supported on the mast generally diametrically opposite the first-mentioned lifting and placement assembly for disposition of one of the lifting and placement assemblies in the storage position when the other lifting and placement assembly is disposed in the loading position. In this manner, the apparatus may carry two storage containers simultaneously, with the positioning capabilities of the apparatus permitting either lifting and placement assembly to be moved into the loading position for selective offloading of the container carried by the assembly. Either or both of the lifting and placement assemblies may be selectively movable into and out of a position inclined relative to the mast axis to assist in retaining a storage container supported by the lifting and placement assembly against disengagement during transport by the truck.

According to another aspect of the present invention, a novel method is facilitated for loading and offloading a storage container onto and from a bed of a truck for transporting the storage container. Briefly described, the method comprises the steps of positioning the truck with the bed and the lifting and placement assembly adjacent a storage container resting on a ground surface. The storage container is then loaded onto the bed by grasping and lifting the storage container from the ground surface by the lifting and placement assembly in a generally vertical direction to an elevation above the bed, rotating the lifting and placement assembly to move the storage container in a generally horizontal direction into a disposition above the bed, and lowering the lifting and placement assembly to place the storage container in resting disposition on the bed. To offload the storage container from the bed, the storage container is grasped and lifted from the bed by the lifting and placement assembly in a generally vertical direction to an elevation above the bed, the lifting and placement assembly is rotated to move the storage container in a generally horizontal direction into a disposition above the ground surface, and the lifting and placement assembly is lowered to place the storage container in resting disposition on the ground surface.

In embodiments of the apparatus equipped with two lifting and placement assemblies, the method further permits the grasping and lifting of a second storage container from the ground surface by the second lifting and placement assembly in a generally vertical direction to a selected elevation for transport in tandem with the first storage container after the first storage container has been placed onto the bed by the first-mentioned lifting and placement assembly. The second lifting and placement assembly may be inclined relative to horizontal to maintain grasping engagement with the second storage container during transporting thereof.

### BRIEF DESCRIPTION OF THE DRAWINGS

FIG. 1 is a schematic side elevational view of a transport truck equipped with one contemplated embodiment of an apparatus for loading and offloading storage containers onto and from a bed of the truck in accordance with the present invention;

FIG. 2 is a schematic top plan view of the truck and apparatus of FIG. 1;

FIGS. 3-5 are schematic side elevational views similar to FIG. 1, depicting sequential steps in the operation of the apparatus, in accordance with the method of the present invention; and

FIG. 6 is another schematic side elevational view of a transport truck equipped with an alternative embodiment of the present storage container loading and offloading apparatus.

### DETAILED DESCRIPTION OF THE PREFERRED EMBODIMENTS

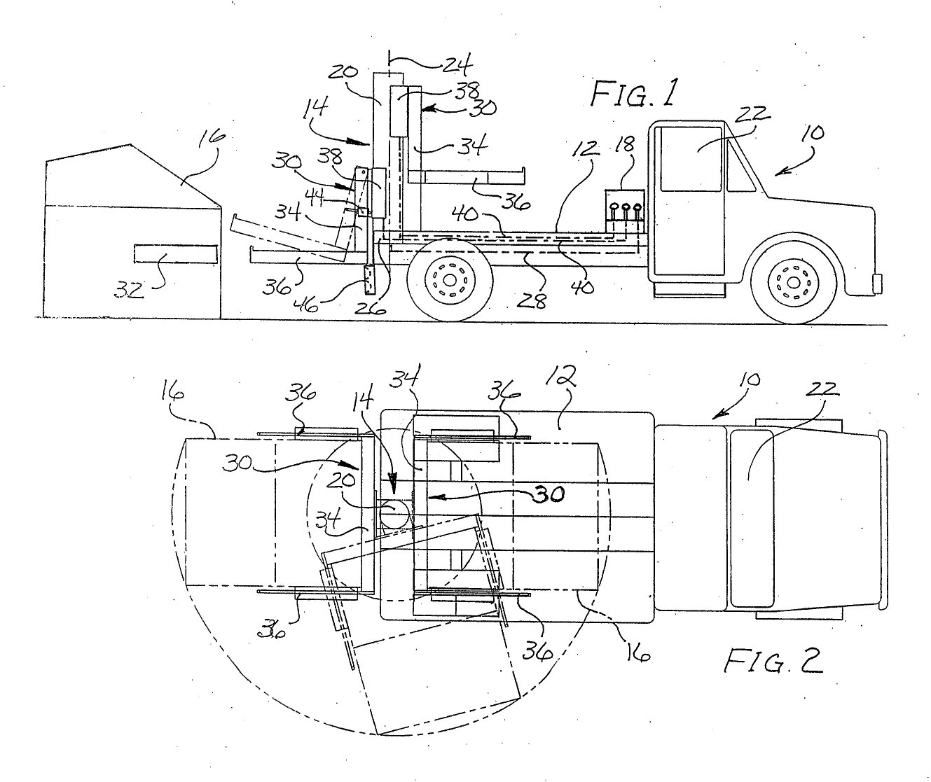

Referring now to the accompanying drawings and initially to FIGS. 1 and 2, a conventional form of transport truck of the type commonly referred to as a flat bed truck is depicted generically at 10 and is equipped with an apparatus according to the present invention, generally indicated at 14, for loading and offloading trash/refuse containers onto and from the bed 12 of the truck 10. As more fully described hereinafter, the apparatus 14 in the illustrated embodiment is adapted particularly for the loading and offloading of containers of the type commonly referred to as dumpsters, such as depicted generically at 16 in FIG. 1.

The truck 10 per se forms no part of the present invention other than as the environment in which the present apparatus 14 is utilized. Any of various forms of flatbed and similar transport or hauling trucks are suitable for accommodating and utilizing the apparatus 14 of the present invention. Basically, the truck 10 must have a suitable powertrain and suspension system, and a suitable form of support structure such as the bed 12, to be capable of transporting loads of the size and weight commensurate with the various typical forms of dumpster-style containers known and in current use, and as will be more fully described and understood hereinafter, the truck 10 should preferably have an alternative power source for operation of the apparatus 14, such as a hydraulic power system comprised of a motor, pump and fluid reservoir as generically depicted at 18. Such hydraulic power systems are well known and in widespread conventional use so as to need no further description herein.

The loading and offloading apparatus 14 basically comprises a mast structure 20 mounted in upstanding relation on or immediately adjacent to the bed 12 of the truck 10, preferably at the rewardmost end of the bed 12 most distal from the driver's compartment 22 and preferably in alignment with the longitudinal centerline through the lengthwise frame structure of the truck 10. The upstanding disposition of the mast structure 20 defines an upright axis 24 and the mast structure 20 is supported by a rotatable structure, shown only schematically at 26, so as to be rotatable about the axis 24. As will be understood by persons skilled in the art, any of various rotatable mounting structures may be utilized to support the mast structure 20, e.g., a turntable, bearing or gear structure. Preferably, the rotatable structure 26 is adapted for selective hydraulic operation via the hydraulic power system 18, as schematically symbolized by the broken line hydraulic circuit depicted at 28, for reciprocal clockwise and counterclockwise rotation through a range of motion of at least approximately 180 degrees, as depicted in FIG. 2.

The loading and offloading apparatus 14 further includes at least one, and preferably a pair of, lifting and placement assemblies, generally indicated at 30, supported at diametrically opposite sides of the mast structure 20, with each lifting and placement assembly 30 being configured and adapted for grasping engagement with a dumpster 16. As is well known, dumpsters 16 typically include a pair of lifting sleeves 32 disposed horizontally at opposite outward sides of the structural body of the dumpster to receive arms or forks of a compatible lifting mechanism, such as a conventional forklift type mechanism. Accordingly, it is contemplated that each loading and offloading apparatus 14 may advantageously be a forklift structure having a main transverse frame 34 with arms or forks 36 projecting outwardly therefrom in spaced-apart parallel relationship corresponding to the spacing between the sleeves 32 on opposite sides of a dumpster 16, all supported on a hydraulically-operated base assembly 38 mounted on the mast structure 20. Each of the two lifting and placement assemblies 30 are thereby adapted for independent movement upwardly and downwardly along the mast structure 20 under the control of the hydraulic power system 18 as schematically symbolized by the broken line hydraulic circuits 40 to the two lifting and placement assemblies 30.

Owing to the diametrically opposed disposition of the lifting and placement assemblies 30, at the opposite extremes of the 180 degree rotational movement of the mast structure 20 one lifting and placement assembly 30 is disposed in a storage position facing the driver's compartment 22 of the truck 10 with the respective forks 36 extending over the bed 12 of the truck 10 generally in parallel relation to and on opposite sides of the longitudinal centerline of the truck frame, while the other lifting and placement assembly 30 is disposed in a loading position facing rearwardly away from the truck bed 12. Upon reciprocated motion of the mast structure 20 into its opposite 180 degree removed position, the two lifting and placement assemblies 30 move through a generally horizontal plane to reverse positions with one another.

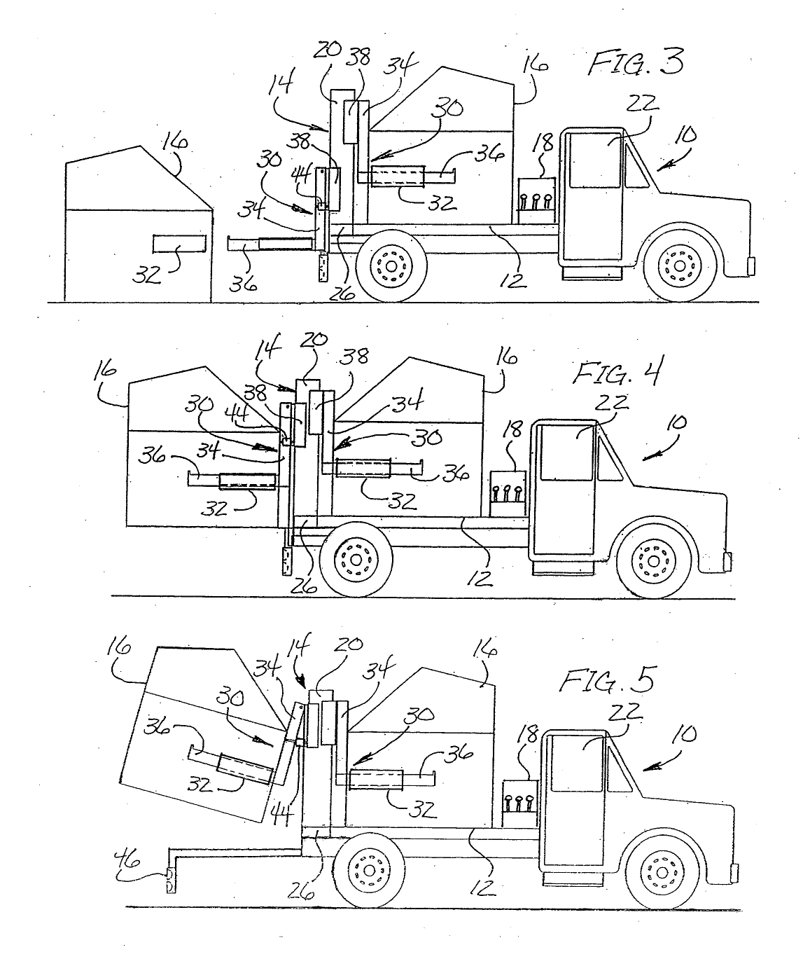

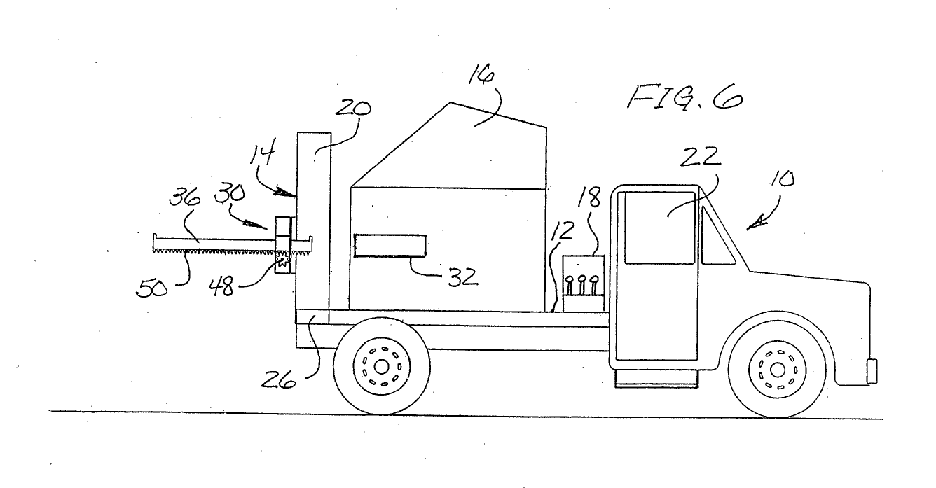

The manner and methodology of operating the loading and offloading apparatus 14 in accordance with the present invention may thus be understood with additional reference to the drawings of FIGS. 3-5. Initially, with the truck bed 12 empty, the truck 10 is driven to the site of a dumpster 16 to be moved. During transport operation of the truck 10, the lifting and placement assemblies 30 are preferably positioned upwardly along the mast structure 20. As depicted in FIG. 1, upon reaching the dumpster site, the truck 10 is positioned with the rear end of the bed 12 adjacent the dumpster 16 and with the forks 36 of the rearwardly facing lifting and placement assembly 30 aligned at opposite sides of the dumpster 16 generally in the vertical planes of the opposed sleeves 32. The rearwardly facing lifting and placement assembly 30 is then hydraulically operated to be lowered along the mast structure 20 to position its forks 36 in horizontal alignment with the sleeves 32. The truck 10 is then driven in reverse a sufficient distance to insert the forks 36 into and through the sleeves 32. Thereupon, the rearwardly facing lifting and placement assembly 30 is hydraulically moved upwardly along the mast structure 20 to lift the dumpster 16 from the adjacent ground surface and to raise it to a selected elevation slightly above the truck bed 12. The hydraulic power system 18 is then operated to rotate the mast structure 20 to its opposite 180 degree removed position to move the rearwardly facing lifting and placement assembly 30 from the loading position into the forwardly facing storage position so as to dispose the dumpster 16 over the bed 12. Thereupon, the lifting and placement assembly 30 is lowered sufficiently to place the dumpster 16 in resting position on the bed 12, as depicted in FIG. 3.

As a result of the above-described steps, the other lifting and placement assembly 30 is moved from the forwardly facing storage position into the rearwardly facing loading position. If desired, the free lifting and placement assembly 30 is now in position to facilitate engagement with and lifting of a second dumpster 16 off the ground surface to a selected transport elevation by the same sequence of steps, as depicted by FIGS. 3 and 4. The second dumpster 16 may be transported in such position by the truck 10 along with the first dumpster 16 on the truck bed 12, whereby the truck 10 is uniquely adapted for the tandem transport of both dumpsters 16 simultaneously. To mitigate against any possible risk that the second dumpster 16 could possibly slide off the forks 36 of the rearwardly facing lifting and placement assembly 30, each lifting and placement assembly 30 may additionally be equipped with an auxiliary hydraulic drive, depicted schematically at 44 in FIG. 1, for pivoting the rearward lifting and placement assembly into an upwardly inclined orientation relative to the mast axis 24 causing the dumpster 16 to rest gravitationally against the transverse frame 34. In addition, the truck 10 may optionally be equipped with a rearwardly extendable taillight bar 46 to move the brake lights and backup lights of the truck 10 rearwardly to a position beneath the rearward dumpsters 16, as may be necessary to comply with prevailing vehicle equipment laws and regulations.

When it is desired to offload either dumpster 16, the same steps are executed in reverse. If it is desired to first offload the dumpster carried by the lifting and placement assembly 30 in the rearwardly facing loading position, the mast structure need not be rotated and the rearward lifting and placing assembly 30 is merely lowered and returned to its non-inclined disposition to place the dumpster 16 onto the adjacent ground surface. If it is desired to first offload the dumpster carried by the lifting and placement assembly 30 in the forwardly facing storage position, the lifting and placement assembly 30 is raised sufficiently to lift the dumpster off the truck bed 12 and then the mast structure 20 is rotated to move the lifting and placement assembly 30 into the reawardly facing loading position, whereupon the lifting and placement assembly 30 is lowered to place the dumpster 16 onto the adjacent ground surface.

Persons skilled in the relevant art will readily recognize and understand that the loading and offloading apparatus 14 of the present invention offers numerous distinct advantages over known conventional apparatus for transporting dumpsters. First, the apparatus 14 is of a desirably simple and compact construction, readily adaptable for retrofitting on any of various types of existing transport trucks. In contrast to conventional transport trucks adapted for hauling a single dumpster at a time, the ability of the present apparatus to enable a truck to transport two dumpsters simultaneously facilitates unique efficiencies in moving dumpsters from one location to another and replacing full dumpsters with empty dumpsters, in particular, reducing the number of back-and-forth trips and the attendant excess mileage required. Further, the unique rotational manner of operation of the apparatus 14 enables either of two dumpsters being transported to be selectively offloaded without having to reposition, or to unload and then reload, one dumpster.

It will also be apparent to persons skilled and knowledgeable in the relevant art that the present loading and offloading apparatus 14 is susceptible of various additional embodiments than just the embodiment illustrated and described in FIGS. 1-5. For example, FIG. 6 illustrates one contemplated alternative embodiment wherein only a single lifting and placement assembly 30 is utilized. In this embodiment, the spaced-apart forks 36 are extendable and retractable via a pinion drive gear 48 positioned on the transverse frame 34 in engagement with a gear rack 50 formed along the length of each fork 36. Through the use of this mechanism, the forks 36 may be retracted out of a dumpster 16 after placement onto the truck bed 12 and extended in the opposite rearward direction into position for lifting engagement of a second dumpster. It is further contemplated that the apparatus 14 may be installed on a truck having an extended bed of sufficient length to support multiple dumpsters on the bed, whereby the apparatus 14 may permit a single truck to transport three or more dumpsters at a time. In such an embodiment, the truck bed may be equipped with appropriate means for moving dumpsters along the bed toward and away from the loading and offloading apparatus, e.g., a sliding deck or roller system along the bed or the like. These and other embodiments utilizing a rotating loading and offloading apparatus are deemed to be within the scope of and are not to be excluded from the present invention.

It will therefore be readily understood by those persons skilled in the art that the present invention is susceptible of broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. In a truck having a bed for transporting a storage container thereon, apparatus for loading and offloading a storage container onto and from the bed, the apparatus comprising:
a mast mounted in upstanding disposition relative to the bed and defining a mast axis, a container lifting and placement assembly configured for grasping engagement with the storage container,
the lifting and placement assembly being supported on the mast for selective movement upwardly and downwardly along the mast axis and for selective movement rotationally about the mast axis between a loading position facing away from the bed and a storage position disposed over the bed to facilitate selective positioning and movement of the assembly relative to the mast and the bed for grasping, lifting, moving, lowering and placing a storage container between a ground surface adjacent the truck and the truck bed.

2. Apparatus in a truck for loading and offloading a storage container onto and from a bed of the truck according to claim 1, wherein the bed has an end rearwardly of the truck, the mast being mounted adjacent the rear end of the bed.

3. Apparatus in a truck for loading and offloading a storage container onto and from a bed of the truck according to claim 1, wherein the lifting and placement assembly is rotatable at least approximately 180 degrees about the mast axis.

4. Apparatus in a truck for loading and offloading a storage container onto and from a bed of the truck according to claim 1, wherein the lifting and placement assembly includes projecting spaced-apart arms for engagement with a storage container.

5. Apparatus in a truck for loading and offloading a storage container onto and from a bed of the truck according to claim 1, further comprising a second lifting and placement assembly supported on the mast generally diametrically opposite the first-mentioned lifting and placement assembly for disposition of one said lifting and placement assembly in said storage position when the other lifting and placement assembly is disposed in said loading position.

6. Apparatus in a truck for loading and offloading a storage container onto and from a bed of the truck according to claim 1, wherein the lifting and placement assembly is selectively movable into and out of a position inclined relative to the mast axis.

7. Apparatus in a truck for loading and offloading a storage container onto and from a bed of the truck according to claim 1, wherein lifting and placement assembly includes hydraulic means for actuating said upward, downward and rotational movements thereof.

8. A method of loading and offloading a storage container onto and from a bed of a truck for transporting the storage container, the method comprising:
providing the truck with a lifting and placement assembly mounted adjacent the bed,
positioning the truck with the bed and the lifting and placement assembly adjacent a storage container resting on a ground surface,
loading the storage container onto bed by:
grasping and lifting the storage container from the ground surface by the lifting and placement assembly in a generally vertical direction to an elevation above the bed,
rotating the lifting and placement assembly to move the storage container in a generally horizontal direction into a disposition above the bed, and
lowering the lifting and placement assembly to place the storage container in resting disposition on the bed,
offloading the storage container from the bed by:
grasping and lifting the storage container from the bed by the lifting and placement assembly in a generally vertical direction to an elevation above the bed,
rotating the lifting and placement assembly to move the storage container in a generally horizontal direction into a disposition above the ground surface, and
lowering the lifting and placement assembly to place the storage container in resting disposition on the ground surface.

9. A method of loading and offloading a storage container onto and from a bed of a truck for transporting the storage container according to claim 8, further comprising:
providing the truck with a second lifting and placement assembly mounted commonly with the first-mentioned lifting and placement assembly adjacent the bed, and
with a first storage container placed onto the bed by the first-mentioned lifting and placement assembly, grasping and lifting a second storage container from the ground surface by the second lifting and placement assembly in a generally vertical direction to a selected elevation for transport in tandem with the first storage container.

10. A method of loading and offloading a storage container onto and from a bed of a truck for transporting the storage container according to claim 9, further comprising:
inclining the second lifting and placement assembly relative to horizontal to maintain grasping engagement with the second storage container during transporting thereof
